(19) United States
(12) Patent Application Publication
(10) Pub. No.: US 2006/0224794 A1
(43) Pub. Date: Oct. 5, 2006

(54) Using USB memory device to recover operating system

(76) Inventor: Michael J. Stevens, Fountain, CO (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/097,905

(22) Filed: Apr. 4, 2005

(51) Int. Cl. G06F 13/38

(52) U.S. Cl. 710/62

(57) ABSTRACT

A portable universal serial bus (USB) memory device that is connectable to an instrument having an operating system. The USB memory device includes software stored thereon which, when the USB memory device is connected to the instrument, automatically boots the instrument and causes the operating system of the booted instrument to be automatically recovered.

### REFERENCE TO COMPUTER PROGRAM LISTING APPENDIX SUBMITTED ON COMPACT DISC

A compact disc is included herewith and incorporated by reference herein having thereon a computer program listing appendix in the ASCII uncompressed text format with ASCII carriage return, ASCII line feed and all control codes defined in ASCII, having computer compatibility with IBM PC/XT/AT or compatibles, having operating system compatibility with MS-Windows and including file Visio-USB Recovery Software2.pdf of 74.2 kb, created on Mar. 30, 2005.

### BACKGROUND OF THE INVENTION

### Description of the Related Art

Computer-based instruments are often used in the field for various purposes. For example, a computer-based instrument might be used to monitor traffic on a computer network.

Such computer-based instruments have operating systems which sometimes need to be recovered. There are many reasons why an operating system may need to be recovered. For example, the operating system may need to be recovered in the event of an operating system crash caused by, for example, a software glitch or a power problem.

Conventionally, a computer-based instrument would include a disk drive or a CD drive. If a disk drive is provided, a disk with boot software and recovery software is inserted into the disk drive to boot the instrument and recover the operating system. Similarly, if a CD drive is provided, a CD with boot software and recovery software is inserted into the CD drive to boot the instrument and recover the operating system.

Unfortunately, if an instrument does not include a disk drive or a CD drive, the operating system of the instrument cannot be recovered in the field.

Moreover, an instrument might not have a keyboard, mouse or display. In this case, even if a disk drive or CD drive was provided on the instrument, a user of the instrument does not have any manner in which to respond to questions during a booting or recovery process.

### BRIEF DESCRIPTION OF THE DRAWINGS

Objects and advantages of the present invention will become apparent and readily appreciated from the following description of the preferred embodiments, taken in conjunction with the accompanying drawings of which:

FIG. 1 is a diagram illustrating the connection of a USB memory device to an instrument, according to an embodiment of the present invention.

FIG. 2 is a diagram illustrating a process for using a USB memory device to recover an operating system of an instrument, according to an embodiment of the present invention.

FIG. 3 is an additional diagram illustrating a process for using a USB memory device to recover an operating system of an instrument, according to an embodiment of the present invention.

FIG. 4 is a diagram illustrating an example process for making a USB memory device bootable, according to an embodiment of the present invention.

### DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

As will be described in more detail below, embodiments of the present invention use a universal serial bus (USB) memory device connected to a USB port of an instrument to boot the instrument and recover the operating system of the booted instrument.

More specifically, portable USB memory devices are becoming very popular. According to embodiments of the present invention, a person (such as, for example, a user of an instrument having an operating system) can use a portable USB memory device to store data such as photos, files, etc., in the normal manner that portable USB memory devices are used. Then, when the operating system of the instrument needs to be recovered, the user can make the USB memory device bootable and to include recovery software. The bootable USB memory device can then be used by the user to recover the operating system of the instrument in the field.

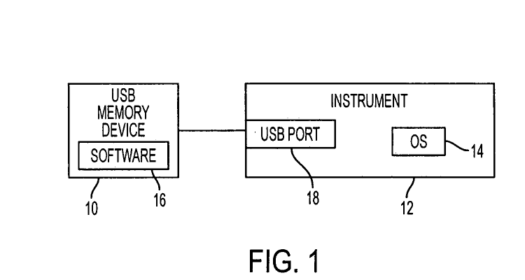

FIG. 1 is a diagram illustrating the connection of a USB memory device to an instrument, according to an embodiment of the present invention. Referring now to FIG. 1, a USB memory device 10 has software 16 stored thereon. A computer-based instrument 12 has an operating system (OS) 14. Instrument 12 also includes a USB port 18.

When USB memory device 10 is connected to USB port 18 of instrument 12, instrument 12 automatically responds to the connected USB memory device 10 in accordance with well-known USB protocols. Therefore, when USB memory device 10 is connected to USB port 18 of instrument 12, software 16 automatically boots instrument 12 and causes operating system 14 of the booted instrument 12 to be automatically recovered.

Instrument 12 might be, for example, a network analyzer for gathering or monitoring network data from a computer network. However, instrument 12 can be many different types of instruments having operating systems, and is not limited to being any particular type of instrument. For example, instrument 12 might simply be a computer having an operating system.

Moreover, instrument 12 might also be, for example, a “headless” instrument, where “headless” indicates that the instrument does not have a keyboard, mouse or display. If instrument 12 is a headless instrument, a user of instrument 12 does not have any manner in which to respond to questions during a booting or recovery process. Therefore, embodiments of the present invention are very effective with a headless instrument, as the headless instrument will be automatically booted and the operating system will be automatically recovered simply by connecting USB memory device 10 to the instrument. However, the present invention is not limited to instrument 12 being a headless instrument.

Further, instrument 12 might not include a disk drive or a CD drive. As described above, conventionally, a disk or CD is used to boot an instrument and recover the operating system in the field. Therefore, if instrument 12 does not include a disk drive or a CD drive, operating system 14 of instrument 12 cannot be conventionally recovered in the field. Embodiments of the present invention would allow operating system 14 to be recovered in the field via USB memory device 10.

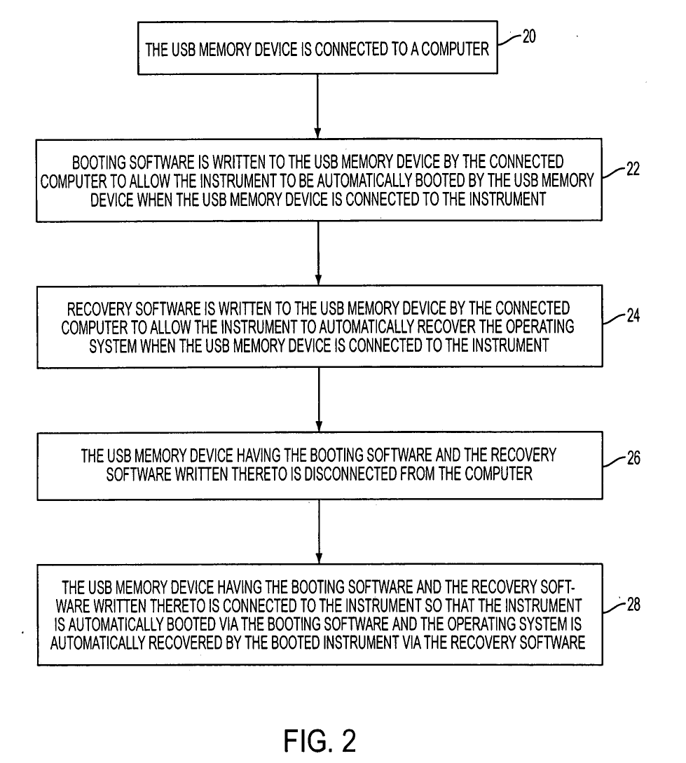

FIG. 2 is a diagram illustrating a process for using USB memory device 10 to recover operating system 14 of instrument 12, according to an embodiment of the present invention. Referring now to FIG. 2, in operation 20, USB memory device 10 is connected to a computer (not illustrated). The computer should have an operating system that is compatible with operating system 14 of instrument 12, so that the computer can write booting software for operating system 14. For example, if operating system 14 is a WINDOWS operating system, then the connected computer should have a WINDOWS operating system which is compatible with operating system 14. The computer might be, for example, a user's computer in the field or at a base location. However, the present invention is not limited to the computer being any particular person's computer or being at any particular location.

From operation 20, the process moves to operation 22, where booting software is written to USB memory device 10 by the connected computer. The booting software is provided to allow instrument 12 to be automatically booted by USB memory device 10 when USB memory device 10 is later connected to instrument 12. The written boot files should be those required to boot operating system 14.

Operating system 14 is not limited to being any particular operating system. For example, operating system 14 might be, for example, a WINDOWS operating system such as, for example, WINDOWS 95, WINDOWS 98, WINDOWS 2000, WINDOWS XP, or any other type of WINDOWS operating system. As an example, if operating system 14 is a WINDOWS operating system, in operation 22, required WINDOWS boot files would be written to USB memory device 10. For example, the following well-known boot files might be written to USB memory device 10: command.com, io.sys and msdos.sys.

WINDOWS operating systems allow a user to create a bootable disk or CD, but do not allow a hard drive to be bootable. This is because, generally, with WINDOWS operating systems, a computer already has one bootable hard drive. WINDOWS operating systems do not want a computer to have more than one bootable hard drive, as this may cause problems or confusion with booting the computer. Therefore, WINDOWS operating systems treat USB memory devices as hard drives, and include security features to prevent booting software from being written to a hard drive or a USB memory device. Accordingly, the present invention circumvents the security features of WINDOWS operating systems to thereby write booting software to USB memory device 10.

More specifically, to circumvent the security features of WINDOWS operating systems, in operation 22, a master boot record and a partition table of USB memory device 10 are configured, for example, in hexadecimal. More specifically, specific hexadecimal values are written to specific sectors of USB drive device 10 to cause USB memory device 10 to automatically boot instrument 12 having a WINDOWS operating system, when USB memory device 10 is later connected to instrument 12.

From operation 22, the process moves to operation 24, where recovery software is written to USB memory device 10 by the connected computer to allow instrument 12 to automatically recover operating system 14 when USB memory device 10 is later connected to instrument 12. The recovery software could, for example, be downloaded to USB memory device 10 from a web site or provided from a CD or other storage medium.

From operation 24, the process moves to operation 26, where USB memory device 10 having the booting software and the recovery software written thereto is disconnected from the computer.

From operation 26, the process moves to operation 28, where USB memory device 10 having the booting software and the recovery software written thereto is connected to USB port 18 of instrument 12. The connection of USB memory device 10 to USB port 12 will cause instrument 12 to be automatically booted via the booting software on USB memory device 10, and will cause operating system 14 to be automatically recovered by the booted instrument via the recovery software on USB memory device 10.

Therefore, embodiments of the present invention use a USB memory device connected to a USB port of an instrument to boot the instrument and recover the operating system of the booted instrument. This operation is significantly different from the conventional use of a disk or CD to boot an instrument and recover the operating system of the instrument.

In addition, as previously described, WINDOWS operating systems allow a user to create a bootable disk or CD, but do not allow a hard drive to be bootable. This is because, generally, with WINDOWS operating systems, a computer already has one bootable hard drive. WINDOWS operating systems do not want a computer to have more than one bootable hard drive, as this may cause problems or confusion with booting the computer. Therefore, WINDOWS operating systems treat USB memory devices as hard drives, and include security features to prevent booting software from being written to a hard drive or a USB memory device. Accordingly, embodiments of the present invention circumvent the security features of WINDOWS operating systems to thereby write booting software to USB memory device 10. According to embodiments of the present invention, when the bootable USB memory device is connected to a USB port of an instrument, the instrument will be automatically booted from the USB memory device.

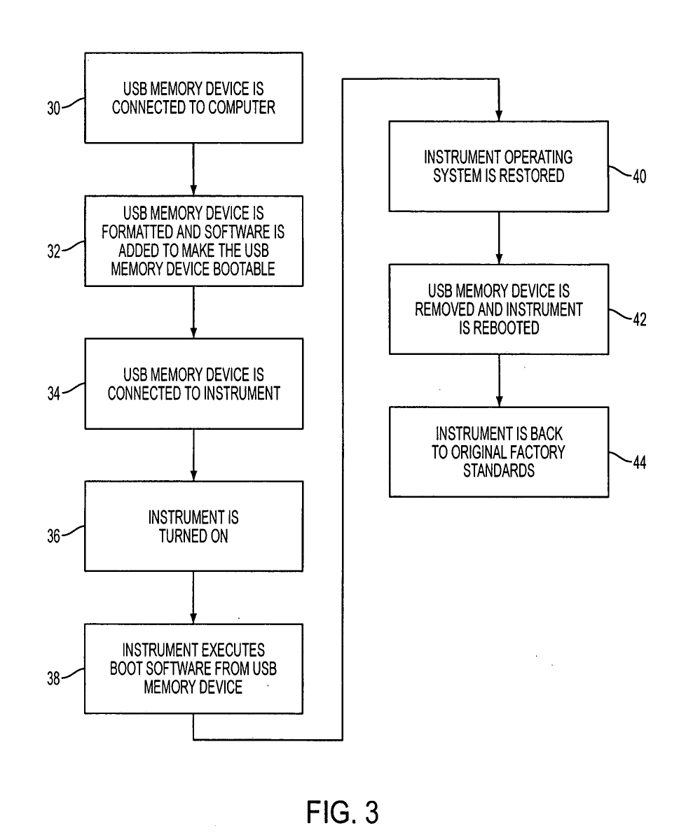

FIG. 3 is an additional diagram illustrating a process for using USB memory device 10 to recover operating system 14 of instrument 12, according to an embodiment of the present invention. The process in FIG. 3 is similar to that in FIG. 2, but shows additional details.

Referring now to FIG. 3, in operation 30, USB memory device 10 is connected to a computer (not illustrated).

From operation 30, the process moves to operation 32, where USB memory device 10 is formatted by the computer and software is added to USB memory device 10 by the computer to make USB memory device 10 bootable. For example, as previously described, boot files are written to USB memory device 10. If required, such as when operating system 14 is a WINDOWS operating system, a master boot record and a partition table of USB memory device 10 is configured to cause USB memory device 10 to automatically boot instrument 12 when USB memory device 10 is later connected to instrument 12. More specifically, specific hexadecimal values are written to specific sectors of USB drive device 10 to configure the master boot record and partition table of USB drive device 10 so that USB drive device 10 is bootable. The specific hexadecimal values which need to be written to specific sectors are dependent on the operating system being used in instrument 12. Such specific hexadecimal values and specific sectors would be determinable by a person of skill in the art based on the operating system being used in instrument 12.

From operation 32, the process moves to operation 34, where USB memory device 10 is connected to USB port 18 of instrument 12.

From operation 34, the process moves to operation 36, where instrument 12 is turned ON.

From operation 36, the process moves to operation 38, where instrument 12 executes boot software from USB memory device 10, to thereby boot instrument 12. Since USB memory device 10 is connected to USB port 18 of instrument 12, instrument 12 will automatically look to instrument 12 when turned ON, and will automatically execute the boot software from USB memory device 10. If operating system 14 is a WINDOWS operating system, in an embodiment of the present invention, instrument 12 would be booted, for example, in DOS.

From operation 38, the process moves to operation 40, where operating system 14 of instrument 12 is automatically restored via the software stored in USB memory device 10.

There are many ways to recover operating system 14 via the software stored in USB memory device 10, and the present invention is not limited to any particular way. For example, an image may be stored in USB memory device 10. The image could, for example, be downloaded to USB memory device 10 from a web site or provided from a CD or other storage medium. When instrument 12 is booted, instrument 12 might then retrieve the operating system or restoring components from the image stored in USB memory device 10.

Or, instrument 12 might have a hard drive with an image stored thereon, where the image includes partitions which are hidden from the user of instrument 12. Instrument 12 can then boot off of USB memory device 10. The software on USB memory device 10 would then cause instrument 12 to access the hidden partitions in the image to thereby restore operating system 14.

More specifically, instrument 12 might have a factory installed hard drive with the operating system installed thereon. The hard drive might then include an active partition and a hidden partition. Instrument 12 would then boot from USB memory device 12, and recovery software on USB memory device 10 causes instrument 12 to access the hidden partition and thereby recover operating system 14.

Therefore, in operation 40, operating system 14 can be restored via an image in instrument 12 and/or an image in USB memory device 10.

From operation 40, the process moves to operation 42, where USB memory device 10 is removed from instrument 12, and the removed instrument 12 is rebooted. The removed instrument 12 will boot off its own hard drive.

The following is an example of the recovery of operating system 14 based on operations 38, 40 and 42 discussed above. For example, if operating system 14 is a WINDOWS operating system, in operation 38, the instrument 12 may be booted in DOS. Then, as an example, in operation 40, recovery software on USB memory device 10 may cause contents of a hidden partition on a hard drive of instrument 12 to be copied to an active partition of the hard drive of instrument 12. The hidden partition is then rehidden. In operation 42, instrument 12 is rebooted from the active partition under WINDOWS.

As an addition example, it may be desirable to replace operating system 14 with a new or upgraded operating system. In this situation, operating system 14 may be recovered by being replaced with the new or upgraded operating system. As an example, USB memory device 10 can be provided with an image for the upgraded or new operating system. Therefore, in operation 40, recovery software on USB memory device 10 may cause the image on USB memory device 10 to be copied to the active and hidden partitions of the hard drive of instrument 12. The hidden partition is then rehidden. In operation 42, instrument 12 is rebooted from the active partition.

There are many different ways to recover operating system 14 via an image in USB memory device 10 and/or an image in instrument 12. The present invention is not limited to any particular way. Moreover, the recovery of operating systems via an image on a boot device and an image on drive of a device being rebooted is known.

From operation 42, the process moves to operation 44, where the rebooting of instrument 12 causes instrument 12 to be, for example, back to original factory standards.

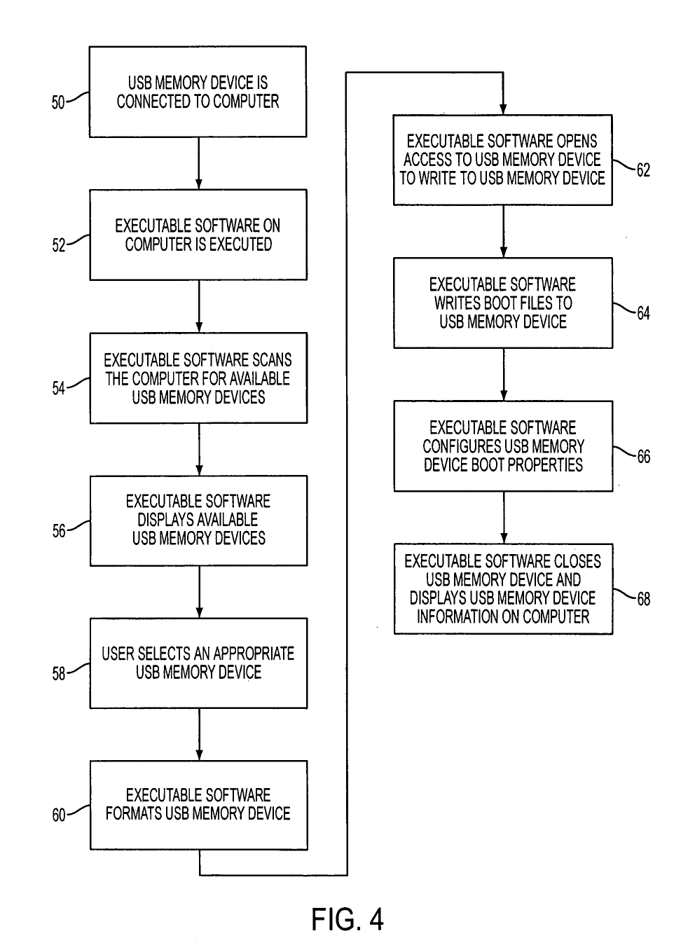

FIG. 4 is a diagram illustrating an example process for making USB memory device 10 bootable, according to an embodiment of the present invention. The process in FIG. 4 provides additional details of operation 20 in FIG. 2, or operation 32 in FIG. 3.

Referring now to FIG. 4, in operation 50, USB memory device 10 is connected to a computer (not illustrated) having executable software thereon. In some embodiments of the present invention, the executable software might be provided to the computer by, for example, a CD. Or, in some embodiments, the executable code might be downloaded by the computer from a web site. However, the present invention is not limited to any particular way to provide the computer with executable code.

From operation 50, the process moves to operation 52, where the executable software on the computer is executed.

From operation 52, the process moves to operation 54, where the executable software scans the computer for available USB memory devices.

From operation 54, the process moves to operation 56, where the executable software displays available USB memory devices.

From operation 56, the process moves to operation 58, where the user selects an appropriate USB memory device.

From operation 58, the process moves to operation 60, where the executable software formats USB memory device 10.

From operation 60, the process moves to operation 62, where the executable software opens access to USB memory device 10 to write to USB memory device 10.

From operation 62, the process moves to operation 64, where the executable software writes boot files to USB memory device 10. For example, as discussed above, if operation system 14 is a WINDOWS operating system, the executable software writes appropriate boot files for booting the WINDOWS operating system.

From operation 64, the process moves to operation 66, where the executable software configures boot properties of the USB memory device. For example, as discussed above, if operating system 14 is a WINDOWS operating system, the executable code configures a master boot record and a partition table of USB memory device 10. The master boot record and partition table are configured by rewriting the master boot record and partition table.

From operation 66, the process moves to operation 68, where the executable software closes USB memory device 10 and displays USB memory device information on the computer.

This application includes a computer program listing appendix which was submitted on compact disc. The computer program provides an embodiment of the present invention corresponding to the process in FIG. 4.

Various embodiments of the present invention are described in relation to a WINDOWS operating system. However, the present invention is not limited to a WINDOWS operating system.

Various embodiments of the present invention relate to a USB memory device, such as USB memory device 10. USB memory device 10 might be, for example, a portable USB memory device. Such a portable USB memory device might be, for example, a commonly available USB pen device.

A process such as that, for example, in FIG. 4, can be implemented by a computer program which is used by a person to make a USB drive device bootable. The person using the computer program might be, for example, a user of instrument 12.

More specifically, portable USB memory devices are becoming very popular. According to embodiments of the present invention, a person (such as, for example, a user of instrument 12) can use a portable USB memory device to store data such as photos, files, etc., in the normal manner that portable USB memory devices are used. Then, when the operating system of the instrument needs to be recovered, the user can make the USB memory device bootable and to include recovery software. The bootable USB memory device can then be used by the user to recover the operating system of the instrument in the field. However, data which was previously written on the USB memory device before being made bootable would typically be lost.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus comprising:
a universal serial bus (USB) memory device connectable to an instrument having an operating system, the USB memory device comprising software stored thereon which, when the USB memory device is connected to the instrument, automatically boots the instrument and causes the operating system of the booted instrument to be automatically recovered.

2. An apparatus as in claim 1, wherein the instrument is a headless instrument.

3. An apparatus as in claim 1, wherein the operating system is a WINDOWS operating system.

4. An apparatus as in claim 2, wherein the operating system is a WINDOWS operating system.

5. A method comprising:
configuring a master boot record and a partition table of a universal serial bus (USB) memory device to cause the USB memory device to automatically boot an instrument having an operating system when the USB memory device is connected to the instrument.

6. A method as in claim 5, further comprising:
writing recovery software to the USB memory device to allow the instrument to automatically recover the operating system when the instrument is connected to the USB memory device.

7. A method as in claim 6, further comprising:
connecting the USB memory device to the instrument having the configured master boot record and partition table and the recovery software written thereto so that the instrument is automatically booted and the operating system is automatically recovered by the booted instrument.

8. A method as in claim 5, wherein said configuring comprises rewriting the master boot record and the partition table in hexadecimal.

9. A method as in claim 5, wherein the operating system is a WINDOWS operating system.

10. A method as in claim 8, wherein the operating system is a WINDOWS operating system.

11. A method as in claim 5, wherein the instrument is a headless instrument.

12. A method as in claim 7, wherein the operating system is a WINDOWS operating system and the instrument is a headless instrument.

13. An apparatus comprising:
means for configuring a master boot record and a partition table of a universal serial bus (USB) memory device to cause the USB memory device to automatically boot an instrument having an operating system when the USB memory device is connected to the instrument; and
means for writing recovery software to the USB memory device to allow the instrument to automatically recover the operating system when the instrument is connected to the USB memory device and after the instrument is automatically booted.

14. A method comprising:
connecting a universal serial bus (USB) memory device to a computer;
writing booting software to the USB memory device by the connected computer to allow an instrument connectable to the USB memory device and having an operating system to be automatically booted by the USB memory device when the USB memory device is connected to the instrument;
writing recovery software to the USB memory device by the connected computer to allow the instrument to automatically recover the operating system when the USB memory device is connected to the instrument;
disconnecting the USB memory device having the booting software and the recovery software written thereto from the computer; and
connecting the USB memory device having the booting software and the recovery software written thereto to the instrument so that the instrument is automatically booted via the booting software and the operating system is automatically recovered by the booted instrument via the recovery software.

15. A method as in claim 14, wherein the USB memory device comprises a master boot record and a partition table, and said writing booting software comprises:
configuring the master boot record and the partition table to cause the USB memory device to automatically boot the instrument when the USB memory device is connected to the instrument.

16. A method as in claim 14, wherein the instrument is a headless instrument.

17. A method as in claim 14, wherein the operating system is a WINDOWS operating system.

18. A method as in claim 16, wherein the operating system is a WINDOWS operating system.

19. A method as in claim 15, wherein said configuring the master boot record and the partition table comprises writing hexadecimal values to sectors of the USB memory device to cause the USB memory device to automatically boot the instrument when the USB memory device is connected to the instrument

20. A method as in claim 15, wherein the operating system is a WINDOWS operating system.
